(19) United States
(12) Patent Application Publication
(10) Pub. No.: US 2017/0014964 A1
(43) Pub. Date: Jan. 19, 2017

(54) Methods and apparatus for distance sensing used in combination with a linear actuator

(71) Applicant: Systems, Machines, Automation Components Corporation, Carlsbad, CA (US)

(72) Inventor: Edward A. Neff, Cardiff-by-the-Sea, CA (US)

(21) Appl. No.: 15/004,825

(22) Filed: Jan. 22, 2016

Related U.S. Application Data
(60) Provisional application No. 62/107,307, filed on Jan. 23, 2015.

(51) Int. Cl. B23Q 17/24; G01S 17/08; G05B 19/402; B23P 19/10

(52) U.S. Cl. CPC B23Q 17/2419; B23P 19/10; G01S 17/08; G05B 19/402; G05B 2219/45165; G05B 2219/37423

(57) ABSTRACT

A system and method for measuring a distance to a target work surface to precisely position a tool assembly coupled to an actuator. The method includes measuring a distance to a work surface using a distance sensor, moving the tool assembly into an approach position, the approach position being adjacent to a location on the work surface. The tool assembly is then moved from the approach position to the location on the work surface pursuant to a soft landing procedure. The soft landing procedure may include determining that the tool assembly has moved into soft contact with the target work surface. Methods also include topologically mapping a work surface, comparing map data to predefined data, and adjusting a positioning routine. Additionally, methods include optimizing actuator movements to timely measure distances from a distance sensor to a location on a work surface with minimal actuator movement.

### CROSS-REFERENCE TO RELATED APPLICATIONS

This application claims priority to, and the benefit of, U.S. Provisional Application No. 62/107,307, filed Jan. 23, 2015, which is incorporated by reference herein in its entirety for all purposes.

### FIELD

The present disclosure pertains generally to machines which are useful for automated assembling or manufacturing an end product. More particularly, the present disclosure pertains to methods for reducing the time required for actuators to move assembly machine parts during automated assembly or manufacture of the end product. The present disclosure is particularly, but not exclusively, useful for the manufacture of end products that incorporate delicate or fragile components that require precision positioning of a tool assembly and soft contact forces during placement of the end product.

### BACKGROUND

Quality control and process throughput are important in the manufacture of components in an assembly process. Often, sensitive components are manufactured in high volumes with precise dimensions and have tight critical tolerance requirements. Automated machines that utilize actuators are used to build, inspect, measure and determine if one or more critical dimensions of the component are within tolerance. For example, pick-and-place machines operate at high-speeds to assemble circuit boards using actuators in multiple axes to pick-up electronic components and precisely place them on the circuit board. Other examples include using a tool assembly with a moving coil actuator to precisely measure a dimension of interest. The measurement is then used to determine if the dimension is within a tolerance window.

Linear actuators are mechanical devices which are used to perform repetitive actions requiring linear motion. For example, linear actuators can be used in an assembly plant for placing caps on bottles, for automatically stamping or labeling mail, for glass cutting, for placing chips on circuits, for testing various buttons or touch areas on electronic devices, for automation, and for a wide variety of other purposes as well.

When considering the operation of a machine that is to be used for the purpose of either assembling separate individual component parts into an end product, or moving a tool into contact with a work surface of the end product, the consequences of the manufacturing process on the end product, as well as process throughput, needs to be addressed. In some instances, increased process throughput can be achieved by increasing the speed of the actuator. However, this can result in reduced quality and increased failures due to the tool assembly contacting the work piece with greater speed and force. For example, a machine can be used for the manufacture of an end product that incorporates a tool assembly that first picks up a component and second places it, for example, into contact with a work surface (or a target work surface) on an end product. Because the machine operates to move a first body (the tool assembly with the component) into contact with a second body (the target work surface of the end product), forces are generated against both bodies by this action. It happens, however, that many end products incorporate very delicate and fragile components that can be easily damaged if the contact forces that are generated during assembly of the end product become too large. Consequently, in order to avoid damage to the end product, it is often desirable to minimize forces generated against specified component parts of the end product during its assembly or manufacture. However, precise operations are often slow and result in decreased process throughput.

Accordingly, a need exists for methods and apparatus for moving a tool assembly at high speeds to increase process throughput, while providing precise, but soft contact between the tool assembly, the component, and the work surface to control the contact forces.

### SUMMARY

Methods and systems are described herein that can measure a distance to a target work surface in order to, for example, precisely position a tool assembly. One disclosed method includes measuring a distance to a work surface using a distance sensor, moving the tool assembly coupled to an actuator into an approach position, the approach position being adjacent to a location on the work surface. The tool assembly is then moved from the approach position to the location on the work surface pursuant to a soft landing procedure. The soft landing procedure can include determining that the tool assembly has moved into soft contact with the target work surface. Methods also include topologically mapping a work surface, comparing map data to predefined data, and adjusting a positioning routine. Additionally, methods include optimizing actuator movements to timely measure distances from a distance sensor to a location on a work surface with minimal actuator movement.

A system according an embodiment of the present invention can include an electrical, moving coil linear actuator configured to actuate at variable speed and including an encoder to provide positioning feedback. A tool assembly is mechanically coupled to the actuator and configured to at least one of couple to a component, dispense a material, engrave and/or cut a work surface, and weld a work surface. A laser measurement sensor is mechanically coupled to the actuator and communicatively coupled to a controller. The laser measurement sensor is configured to detect the work surface and/or to measure a distance from the laser measurement sensor to the work surface and provide a signal representative of the distance to the controller. The controller is communicatively coupled to the actuator and to the laser measurement sensor. The controller is configured to provide a control signal to the actuator in response to the signal received from the laser measurement sensor.

A method for positioning a tool assembly of an actuator in relation to a location on a work surface is also described. A distance sensor is positioned adjacent to a location on the work surface. The location corresponds to a position of the tool assembly. A distance is sensed from the location on the work surface to the distance sensor. The distance corresponds to the position of the tool assembly from the location on the work surface. A signal is provided that is representative of the distance from the location on the work surface to the distance sensor. The distance sensed is then compared to a predefined or predetermined distance. A routine is then adjusted based on the comparison. The routine contains information for positioning the tool assembly of the actuator in relation to the location on the work surface.

Also disclosed is a method for positioning a tool assembly of an actuator in relation to a location on a work surface within a system. The system may be calibrated, which includes specifying an origin point for referencing other positions within the system. The work surface is topographically mapped including determining a distance of the location on the work surface to the origin point. Map data is generated representative of the location on the work surface. The map data includes the position of the location on the work surface relative to the origin point. Predefined or predetermined information representative of the location on the work surface is compared to the map data. The predetermined information includes at least an x and a y position of the location on the work surface relative to the origin point. An actuation position of the tool assembly is determined that corresponds to the location on the work surface based on the comparison. An actuation routine is adjusted based on the determination. The actuation routine contains information for at least one of positioning the tool assembly, velocity of the tool assembly, and force applied by the actuator coupled to the tool assembly, in relation to the location on the work surface.

The following U.S. published applications are hereby incorporated herein by reference for all purposes:

application Ser. No. 13/927,075 Application Date Jun. 25, 2013 Publication No. US-2014-0159407-A1 Publication Date Jun. 12, 2014 Title ROBOTIC FINGER

application Ser. No. 13/927,076 Application Date Jun. 25, 2013 Publication No. US-2014-0159408-A1 Publication Date Jun. 12, 2014 Title ROBOTIC FINGER

Application No. PCT/US2013/047727 Application Date Jun. 25, 2013 Publication No. WO 2014/004588 Publication Date Jan. 3, 2014 Title ROBOTIC FINGER

application Ser. No. 13/927,079 Application Date Jun. 25, 2013 Publication No. US-2014-0159514-A1 Publication Date Jun. 12, 2014 Title LOW-COST, REDUCED DIAMETER LINEAR ACTUATOR

application Ser. No. 13/927,078 Application Date Jun. 25, 2013 Publication No. US-2014-0159513-A1 Publication Date Jun. 12, 2014 Title LOW-COST, REDUCED DIAMETER LINEAR ACTUATOR

Application No. PCT/US2013/047728 Application Date Jun. 25, 2013 Publication No. WO 2014/004589 Publication Date Jan. 3, 2014 Title LOW-COST, REDUCED DIAMETER LINEAR ACTUATOR

application Ser. No. 12/184,918 Application Date Aug. 1, 2008 Publication No. US 2009-0058581 A1 Publication Date Mar. 5, 2009 Title COMPACT LINEAR ACTUATOR AND METHOD OF MAKING SAME

Application No. PCT/US2008/071988 Application Date Aug. 1, 2008 Publication No. WO 2009/018540 Publication Date Feb. 5, 2009 Title COMPACT LINEAR ACTUATOR AND METHOD OF MAKING SAME

application Ser. No. 12/020,466 Application Date Jan. 25, 2008 Publication No. US 2008-0258654 A1 Publication Date Oct. 23, 2008 Title COMBINATION PNEUMATIC AND ELECTRIC LINEAR ACTUATOR

Application No. PCT/US2008/052121 Application Date Jan. 25, 2008 Publication No. WO 2008/092124 Publication Date Jul. 31, 2008 Title COMBINATION PNEUMATIC AND ELECTRIC LINEAR ACTUATOR

application Ser. No. 12/188,111 Application Date Aug. 7, 2008 Publication No. US 2009-0040247 A1 Publication Date Feb. 12, 2009 Title MICRO SHIM FOR MOVING COIL ACTUATOR

Application No. 12/622,372 Application Date Nov. 19, 2009 Publication No. US 2010-0133924 A1 Publication Date Jun. 3, 2010 Title COMPACT LINEAR ACTUATOR AND METHOD OF MAKING SAME

application Ser. No. 12/860,809 Application Date Aug. 20, 2010 Publication No. US 2012-0043832 A1 Publication Date Feb. 23, 2012 Title COMPACT LINEAR ACTUATOR WITH ROTARY MECHANISM

application Ser. No. 13/244,156 Application Date Sep. 23, 2011 Publication No. US 2012-0080960 A1 Publication Date Apr. 5, 2012 Title LOW COST MULTI-COIL LINEAR ACTUATOR

Application No. PCT/US2011/053070 Application Date Sep. 23, 2011 Publication No. WO 2012/040620 Publication Date Mar. 29, 2012 Title LOW COST MULTI-COIL LINEAR ACTUATOR

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows a front view of an exemplary actuator with a distance sensor according to an embodiment of the present invention.

FIG. 2 shows a bottom view of an exemplary actuator with a distance sensor according to an embodiment of the present invention.

FIG. 3 shows a perspective view of an exemplary actuator with a distance sensor according to an embodiment of the present invention.

FIG. 4 shows a hardware block diagram an exemplary actuator with a distance sensor according to an embodiment of the present invention.

FIG. 5 is a flowchart describing exemplary operation of the actuator apparatus with a distance sensor according to an embodiment of the present invention.

FIG. 6 is a flowchart describing exemplary operation of the actuator apparatus with a distance sensor according to an embodiment of the present invention.

FIG. 7 is a flowchart describing exemplary operation of the actuator apparatus with a distance sensor according to an embodiment of the present invention.

FIG. 8 is a flowchart describing exemplary operation of an actuator apparatus configured to position a tool assembly in relation to a location on a work surface according to another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Following below are more detailed descriptions of various concepts related to, and embodiments of, inventive systems, methods, and apparatus for distance sensing used in combination with a linear actuator. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

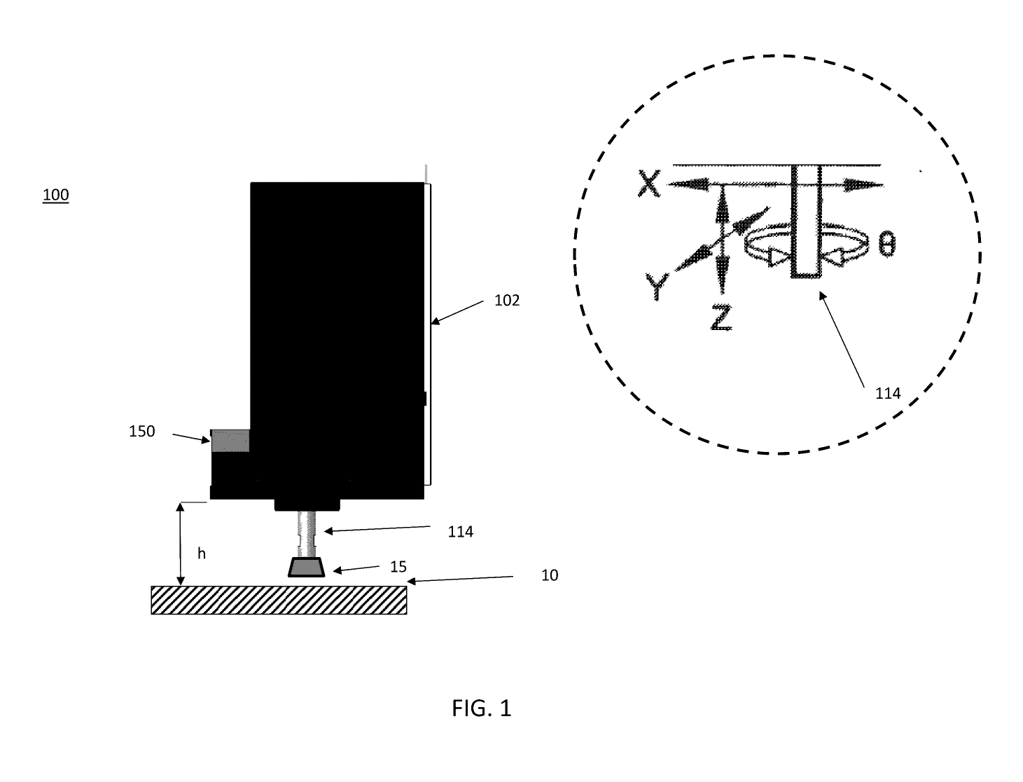

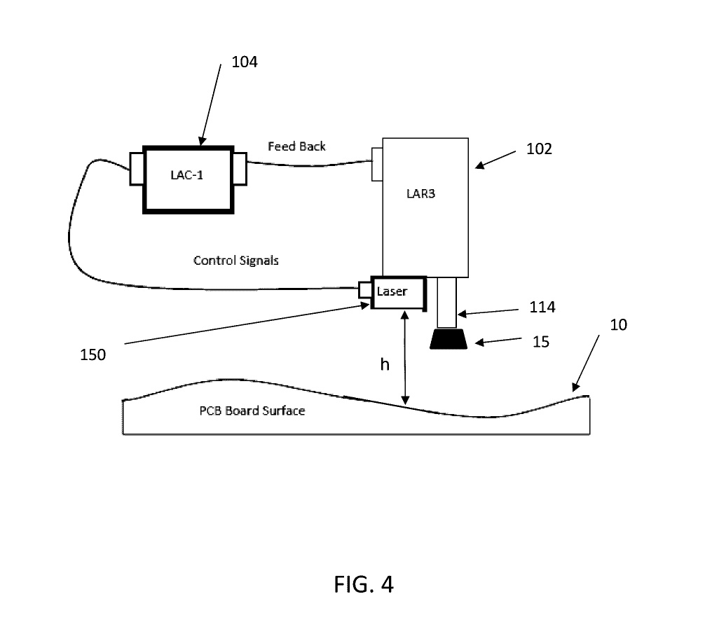

FIG. 1 shows a front view of an exemplary actuator with a distance sensor according to an embodiment of the present invention. Referring FIG. 1, the system 100 includes an actuator 102, a tool assembly 114, and a distance sensor 150. The distance sensor 150 measures a height h, which is in the z direction as shown in the inset, of the distance sensor 150 above a location on the work surface 10. The distance sensor 150 provides an output signal representative of the measured height h to a controller 104 (as shown in FIG. 4) that controls the movements of the actuator 102. Based on the measured height h, the controller 104 is able to precisely position the actuator in a location above the work surface 10. Work surface 10 contains a location where a component 15 may be positioned by tool assembly 114.

The actuator 102 can be any actuator device, such as a pneumatic, hydraulic or electrical actuator. In preferred embodiments, the actuator 102 is an electrical actuator, such as a moving coil actuator (also known as a voice coil actuator) or a moving magnet actuator. It is understood that although one actuator 102 is illustrated, the system 100 can be configured to include more than one actuator. In the illustrated embodiment, the actuator 102 includes a tool assembly 114 that is moveable in at least one axis. For example, as shown in the inset within FIG. 1, and depending on the specific actuator used, the tool assembly 114 may be moved in an x, y and/or z axis relative to the body of the actuator 102 or to the work surface 10. Furthermore, the tool assembly 114 may be rotational (θ) about one or more of the x, y and/or z axes. It is also noted that although the actuator 102 as illustrated shows potentially four axes of actuation, x, y, z, and θ, the actuator 102 may have more than four axes to support additional toolpaths including five, six, and so on up to at least 12 axes, though an actuator may also be provided that has only one, two, or three axis of actuation.

Locations on the work surface 10 or positions of the actuator 102, the tooling assembly 114, or distance sensor 150, can be specified in terms of coordinates along the given axes. Prior to specifying a location or position, an origin point or reference point may first be established. The origin or origin point can be any predetermined point in space including locations on the work surface 10 or within the system 100.

The actuator 102 can include one or more encoders (not shown) that are capable of taking positional measurements about one or more axes. That is, in response to control signals from the controller 104, the actuator 102 sends measurements from its encoders to the controller 104 to indicate the precise positional location of the tool assembly about the relevant axes. In this way the tool assembly 114 may be moved to an approach position relatively close to, but safely away from, a work surface 10 of interest. From the approach position, the tool assembly 114 may optionally perform a “soft-land” operation whereby the tool assembly 114 (or tool assembly 114 with component 15) is brought into contact with a work surface 10 so as not to damage the work surface 10, component 15, tool assembly 114, and/or actuator 102, and to establish an accurate contact location. Additional information about the soft-land operation is set forth in U.S. Pat. No. 5,952,589 entitled “Soft Landing Method for Tool Assembly” (the “'589 patent”) and U.S. Publication No. 2005/0234565 entitled “Programmable Control System for Automated Actuator Operation”, respectively, both of which are hereby incorporated by reference in their entireties for all purposes.

As is discussed in the '589 patent, the soft-land procedure typically involves placing the tool assembly at an approach position. This approach position can be arbitrarily established in accordance with the desires of the operator, but preferably, the approach position places the tool assembly much closer than about one millimeter away from the target work surface. The approach position will generally be dependent on the characteristics of the target work surface; namely, the approach position can be made to be closer to smooth target work surfaces relative to rougher surfaces without substantially increasing the risk of forceful, inadvertent contact. In any event, the tool assembly is placed at the approach position for subsequent movement along a path from the approach position into soft contact with a predetermined point on the target work surface. In other embodiments alternate schemes may be employed for moving the tool assembly from the approach position into contact with the target work surface.

Initially, the tool assembly is held stationary at the approach position. Then, the forces which are acting to hold the tool assembly 114 stationary are changed in magnitude until the inherent static friction forces that have been acting on the stationary tool assembly 114 are overcome. When the static friction forces have been overcome, the system becomes dynamic and the tool assembly 114 advances toward the work surface under the influence of the resultant force.

As the tool assembly 114 is advanced toward the target work surface 10, it is moved rapidly in a position mode until the approach position. From the approach position, the tool assembly proceeds in a soft land mode until contact is made with the target work surface 10. Specifically, several control modes of operation for determining soft contact are possible. In particular, each of these control modes depends on a measurable parameter that is characteristic of the movement of the tool assembly 114. These measurable parameters include i) the tool's travel position on the toolpath toward the work surface (i.e. a position control mode), ii) its velocity (i.e. a velocity control mode), and iii) the acceleration/deceleration of the tool assembly 114 (i.e. torque control mode). In an alternate embodiment, none of the above mentioned measurable parameters are monitored and, instead, the tool assembly 114 is allowed to merely advance into soft contact with the target work surface under the influence of the resultant force (i.e. a basic mode). The position control mode of operation, velocity control mode of operation and the torque control mode of operation are described in further detail in the '589 patent.

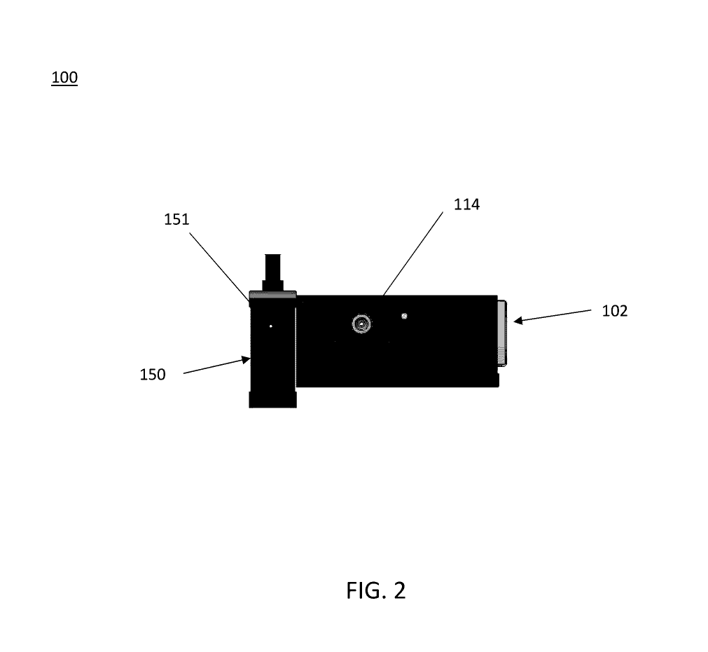

FIG. 2 shows a bottom view of an exemplary actuator 102 with a distance sensor 150 according to an embodiment of the present invention. Distance sensor 150 may include a distance sensor output 151 corresponding to a point of measurement between the distance sensor 150 and the work surface 10. The relative position, including x, y, and z coordinates of the distance sensor output 151 in relation to the tool assembly 114 are known or can be determined. Preferably, the distance sensor 150 is in close proximity to the tool assembly 114 to measure a location on the work surface 10 that is the same measured height h as the location under the tool assembly 114. In other embodiments (not shown), the distance sensor 150 can be part of the tool assembly 114.

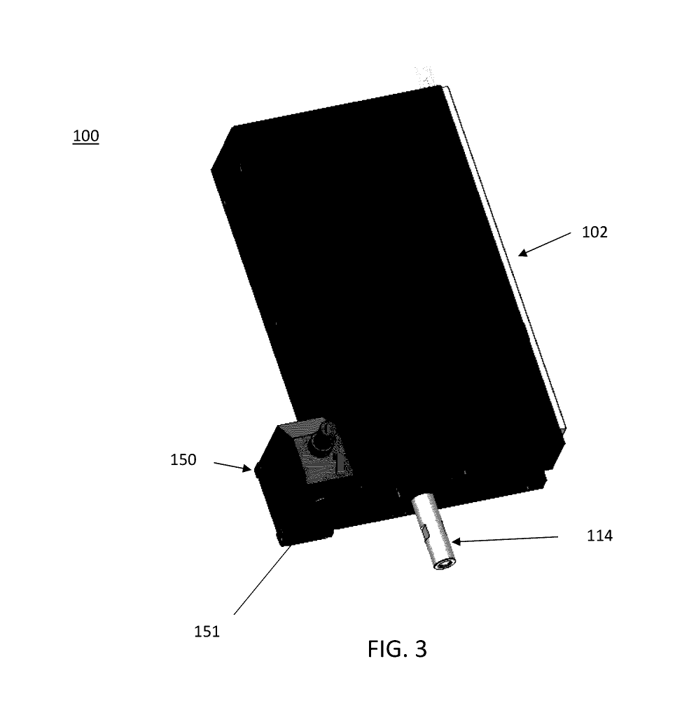

FIG. 3 shows a perspective view of an exemplary actuator 102 with a distance sensor 150 according to an embodiment of the present invention. The distance sensor 150 can be mechanically coupled to the actuator 102. Alternatively, the distance sensor 150 can be incorporated within the body or housing of the actuator 102, for example, at the time the actuator 102 is manufactured. In some embodiments, the distance sensor 150 can be incorporated within the body of the actuator 102 such that distance sensor output 151 can be proximate to tool assembly 114, and in some embodiments, distance sensor output 151 is collinear with a central axis of tool assembly 114.

FIG. 4 shows a hardware block diagram of an exemplary actuator 102 with a distance sensor 150 according to an embodiment. In some embodiments, actuator 102 is an electrical, moving coil linear actuator configured to actuate at variable speed and includes an encoder to provide positioning feedback related to the position of the tool assembly 114. In some embodiments, distance sensor 150 is a laser measurement sensor which emits a laser beam to detect a distance or measured height, h, from the laser measurement sensor 150 to the work surface 10. Laser measurement sensor 150 is mechanically coupled to the actuator 102 and communicatively coupled to a controller 104. Laser measurement sensor 150 is configured to measure a distance h from the laser measurement sensor 150 to the work surface 10 and to provide a signal representative of the distance to the controller 104. In some embodiments, work surface 10 is a printed circuit board surface. The laser measurement sensor can be communicatively coupled to a controller 104 to provide a signal representative of the distance h. In some embodiments, the laser measurement sensor may be electrically coupled to controller 104. In this embodiment the laser measurement sensor may receive power from the controller 104 and provide an output signal to the controller 104 that representative of the distance h. Controller 104 processes the signal representative of distance h and provides a control signal to actuator 102 to precisely adjust the position of the tool assembly 114 in a z direction above the work surface 10. The controller 104 may provide a control signal to the tool assembly 114 to position the tool assembly 115 coupled to component 15 in an approach position. From the approach position, actuator 102 can move tool assembly 114 in a soft land mode until component 15 is in contact with work surface 10. Often it is assumed that a work surface 10 is flat and planar, however, this is not always the case as shown in FIG. 4. By precisely measuring the distance h to the work surface 10, the position of the tool assembly 114 in the z direction can be adjusted to account for distance variations that result from non-planar, non-flat work surfaces 10.

An example of a work surface 10 is the surface of a printed circuit board. In some instances, a circuit board surface is not flat and may have approximately +/−1.5 mm of warping. When placing the component 15 on the circuit board work surface 10, it is often desirable to limit the impact to avoid damaging the fragile component 15. The force of an impact of a component 15 placed on a work surface 10 can be calculated by an equation where the force equals 2*mass*velocity/time. Thus, the impact force can be reduced by decreasing the velocity of tool assembly 114 as it places the component 15 on the circuit board work surface 10, or by increasing the time variable. However, decreasing the velocity of tool assembly 114 reduces process throughput; therefore, it is desirable to decrease the velocity of tool assembly 114 only when the tool assembly 114 is in close proximity to the circuit board work surface 10. For example, when the tool assembly 114 holding the component 15 is about 0.5 mm from the circuit board work surface, the tool assembly velocity can be reduced to a slow, controlled speed to minimize the impact, i.e. a soft land approach. However, when the circuit board work surface 10 has +/−1.5 mm of warping, conservatively setting the tool assembly 114 velocity to a slow speed 0.5 mm above the highest possible point on the circuit board work surface 10 could result in the tool assembly 114 traveling a distance of 3.5 mm in a soft land approach mode with a slow velocity. This scenario can be avoided by measuring the distance h at the location on the work surface 10 that the component is to be placed, and by adjusting the approach position accordingly. By knowing the actual, precise distance to any particular location on the work surface 10, i.e. to micron resolution, the actuator tool assembly 114 can be moved quickly in a position mode to a distance of about 25 microns above the circuit board work surface 10, thereafter, the tool assembly 114 can be placed in a soft land mode for completion of the actuation process.

Generally, noncontacting techniques for quantitatively determining the distance between two points are more desirable than contact measurements due to the risk of damaging the work surface 10, wearing the distance sensor 150, and the time required to complete a contact-type measurement. Suitable non-contacting techniques for sensing the distance to a work surface 10 include intensity-based sensing, triangulation, time-of-flight sensing, confocal sensing, Doppler sensing, and interferometric sensing. For example, a laser measurement sensor can be used to precisely measure the distance, h, to a work surface 10. Other types of distance measurement sensors 150 include ultrasonic sensors and white light interferometric sensors.

In other embodiments electromagnetic proximity sensors, reflective sensors and/or capacitive sensors may be used instead of laser measurement sensors. For example, an inexpensive, commercially-available proximity sensor may be used to generally detect a work surface 10 within a range (e.g., 2 mm) of the sensor. The actuator tool assembly 114 could then be moved quickly to an intermediate position (e.g., 1 mm above the work surface 10) and thereafter moved more slowly to complete the actuation process.

In one example, a laser measurement sensor CD22-35VM12, manufactured by and available from Optex-FA Corporation, is mounted to a LAR31 actuator manufactured by and available from SMAC Inc. The LAR31 actuator includes a tool assembly for picking up surface mounted electronic components. The laser sensor measures a distance in the same direction and parallel to the z direction of actuation. The laser measurement sensor provides an analog output to the actuator's controller amplifier, for example, a LAC-1 manufactured by and available from SMAC Inc. In one example, in a position mode, the tool assembly can be moved 10 mm with 1-2 microns of overshoot in 10-15 milliseconds, followed by a final 25 microns of movement in a soft land mode at a rate of 1 mm/second. The final movement of the tool assembly in a soft land mode is about 10 times slower than conventional electronic assembly processes and results in a reduction in impact force on a component of about 90%.

In some instances, the actuator moves along x, y, z, and θ axes. The actuator 102 and tool assembly 114 can be positioned in a high velocity position mode until the approach position, and thereafter, the tool assembly 114 can be positioning in a soft land mode until contact with the works surface 10. Sensing the distance at each component placement location can result in a faster cycle time compared to conventional pick and place processes, even though measuring the distance results in an added process stage. This is because the slow speed travel, i.e. a soft land mode, of the tool assembly during component placement can be the slowest aggregate stage of the pick and place build process depending on the distance of the approach position above the work surface.

Another example of distance sensing with a linear actuator is during dosing and packaging applications. For example liquid nitrogen is dispensed into lactic bottles. It has been observed that dispensing rates are becoming faster and faster moving from 1,200 containers per minute (CPM) to over 2000 CPM. Integrating a surface detection laser with a nitrogen valve actuator can provide a compact and inexpensive solution compared to expensive separate bottle detection solutions currently employed. Part measurement for quality purposes can be done inline, rather than as a separate process step.

Advantages of the present invention include higher processes throughput and lower process cycle times. Other advantages include reduce component damage including latent damage which results in premature component failures. Furthermore, advantages include reduced stresses on actuators, tool assemblies, components and work surfaces.

In some embodiments, the tool assembly 114 can be a probe assembly that is used to make contact measurements on a work surface 10. By performing a non-contact distance measurement with distance sensor 150, the probe assembly can be rapidly positioned above the work surface 10 followed by a soft land contact. In some embodiments, the tool assembly 114 can also be a pick and place head including a vacuum chuck, mechanical grippers, and/or adhesive chuck. In some embodiments, the tool assembly 114 can be a syringe holder to dispense a liquid or gel, including an adhesive syringe holder to dispense paste, used for example, during semiconductor manufacturing. In some embodiments, the tool assembly 114 can be a laser welder, cutter, ablation, or engraving tool. Because control of the focal point of a laser is critical in these types of applications, is important to precisely determine the distance of the tool assembly 114 above a work surface 10.

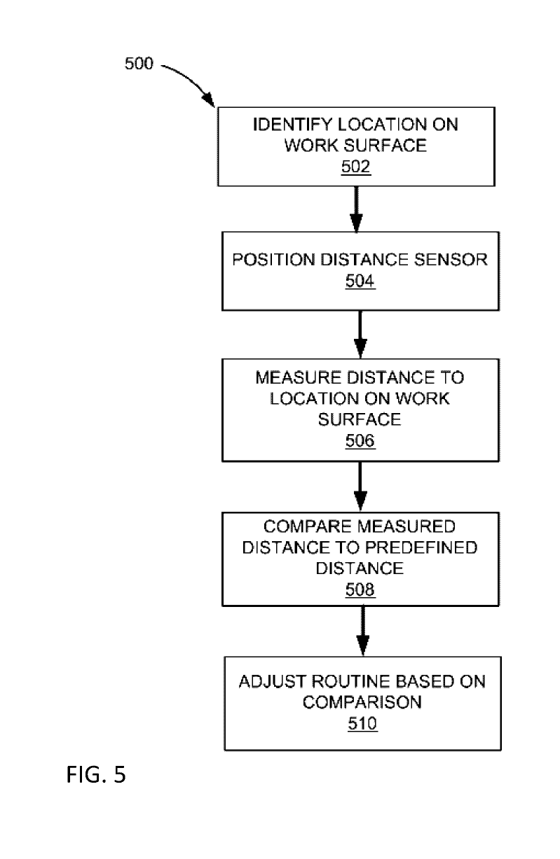

FIG. 5 is a flowchart describing exemplary operation 500 of the actuator apparatus with a distance sensor according to an embodiment of the present invention. In stage 502, the location on the work surface is identified. For example, this may be the location on a printed circuit board surface where an electronic component is to be placed. The location will typically have at least x, y, and z coordinates specified relative to a predefined origin. A distance sensor is then positioned adjacent to the location on the work surface in stage 504, and the distance h from the distance sensor to the work surface is measured in stage 506. The distance h corresponds to the position of a tool assembly from the location on the work surface where the electronic component is to be placed. The distance sensor provides a signal representative of the measured distance h to a controller that controls the operation of the actuator. The distance of the distance sensor above the predefined origin is known, and is compared to the measured distance h to determine a z coordinate of the location on the work surface 508 where an electronic component is to be placed. The routine stored in the controller is adjusted based on the comparison of the distance measured h to the distance of the distance sensor above the predefined origin and the tool assembly can be positioned accordingly in stage 510.

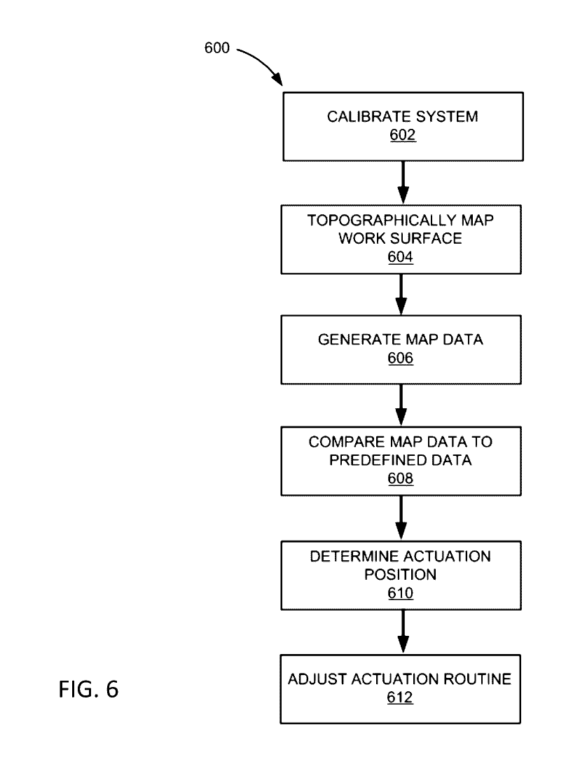

FIG. 6 is a flowchart describing exemplary operation 600 of the actuator apparatus with a distance sensor according to an embodiment of the present invention. In stage 602, the system is calibrated. System calibration includes specifying an origin point from which other positions in the system can be referenced. In stage 604, the work surface is topographically mapped to create a topographic map, 3D contour map, and/or discrete vector map of the work surface. Suitable methods of topographically mapping a work surface include laser scanning and white light interferometry. After topographically mapping, in stage 606, map data is generated representative of locations on the work surface. For example, a processor may be used to digitize a map and create table of coordinates (x, y, and z) a location relative to the origin. The locations can be either specific points on the work surface, or areas comprising multiple points on the work surface. Map data can also include information about the texture, roughness, finish, and composition of the work surface. The map data is compared to predefined information representative of a location in stage 608 using the origin point as common point of reference. For example, a user may predefine a general z coordinate for all locations on the work surface, and then specify a location on the work surface including x,y coordinates where a component is to be placed. Based on the comparison between the map date generated by topographically mapping the work surface and the predefined information including x and y coordinates of a location on the work surface, the actuation position of a tool assembly can be determined in stage 610. The actuation position is adjacent to the location on the work surface where, for example, a component is to be placed. For example, an actuation position can be determined that is 25 microns from the location on the work surface. In stage 612, an actuation routine can be adjusted based on the actuation position previously determined to position the tool assembly. For example, an actuation routine may initially specify that the predefined actuation position is 5 mm above a location on the work surface. After determining the actuation position based on comparing the map data generated by topographically mapping the work surface to the predefined location on the work surface, the actuation routine may be adjusted to move the tool assembly in a high velocity position mode to the determined actuation position, followed by soft land approach toward the location on the work surface. Additionally, the actuation routine may include adjustment of the positioning of the tool assembly and the force applied by the actuator coupled to the tool assembly. Especially in instances where there are large deviations between the measured map data and the predefined information of a location on the work surface, the determined actuation position can be further adjusted as a precaution against measurement and programming error.

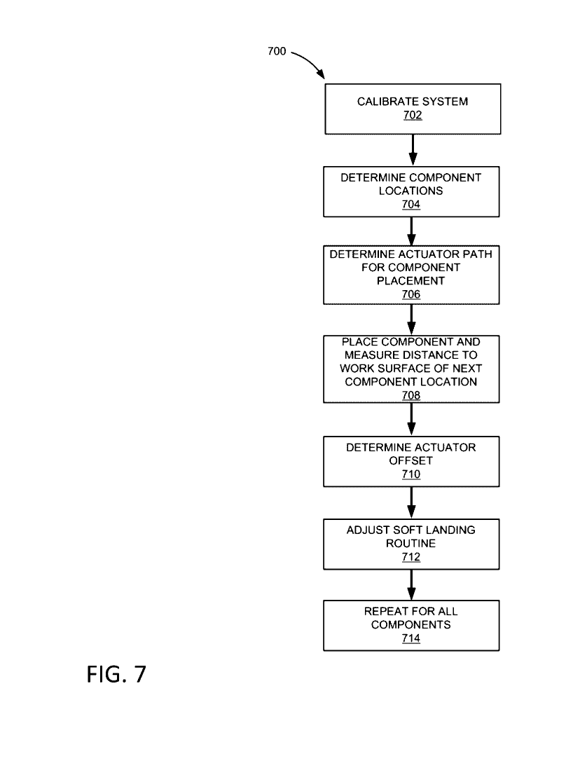

FIG. 7 is a flowchart describing exemplary operation 700 of the actuator apparatus with a distance sensor according to an embodiment of the present invention. In stage 702, the system is calibrated including specifying an origin point from which all each other position can be referenced. In stage 704, the component locations are determined by methods including, but not limited to, optical recognition of the work surface, or predefined by a user. Once the component locations are determined, the path of the actuator for placement of each component on the work surface is determined in stage 706. In one embodiment, the component farthest from the origin is placed first. In this case, the actuator traverses the greatest distance between the origin and the component location on the work surface. After placing a component farthest from the origin, the distance sensor measures the distance to the work surface of the next component location in stage 708 as the actuator travels back to the origin for picking the next component. In this manner, the return path of the actuator travels over the location of the next component to be placed, and is able to take an instantaneous and timely measurement of the next component's location on the work surface. By placing the farthest component first and returning to the origin over the next component's location, actuator movement is reduced resulting in lower process times. By measuring the next component's location shortly before placement of that component on the work surface, any changes in the work surface that occurred during the process may be accounted for (including changes due to thermal expansion or the work surface shifting). Based on the difference between the measured distance and the expected distance at the location of the next component, an actuation location offset or approach position of the tool assembly is determined (stage 710). The soft landing routine is adjusted in stage 712 so that the component is placed on the work surface without damage. In stage 714, the process is repeated until all components have been placed on the work surface. It should be noted that the description of the actuator paths is made in reference to a single point, an origin, and multiple locations on the work surface that are different distances from the origin. The foregoing process also applies where the actuator paths are between multiple locations on the work surface and multiple locations off the work surface. For example, an actuator may travel between a reel of electronic components off of the work surface and multiple locations on the work surface.

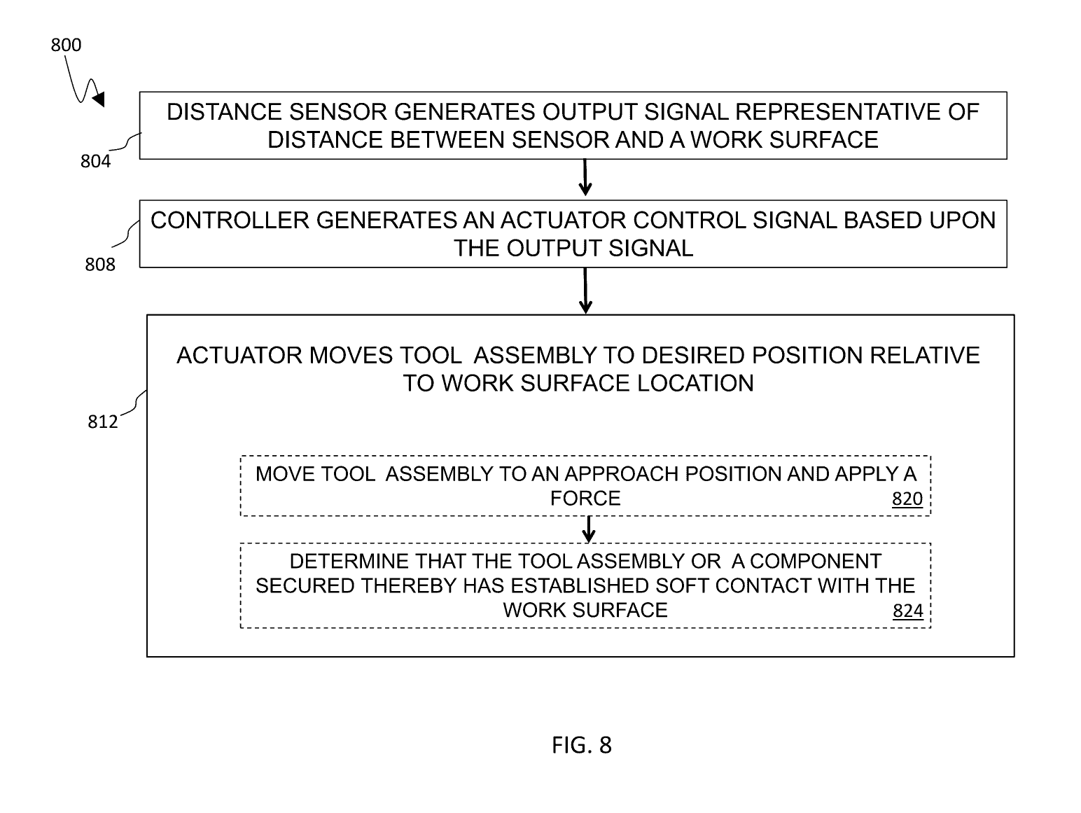

FIG. 8 is a flowchart describing exemplary operation 800 of an actuator apparatus configured to position a tool assembly in relation to a location on a work surface according to another embodiment. In a stage 804, a distance sensor mechanically coupled to the actuator apparatus generates an output signal representative of a distance between the distance sensor and the location on the work surface. A control signal is then generated based upon the output signal (stage 808). The actuator apparatus is operative to move, in response to the control signal, the tool assembly to a desired position relative to the location on the work surface (stage 812). In one embodiment the actuator apparatus moves the tool assembly to an approach position at a predetermined distance from the work surface and applies a force to the tool assembly at the approach position (stage 820). It may be further determined that at least one of the tool assembly or a component secured by the tool assembly has established soft contact with the work surface (stage 824).

Though the foregoing embodiments and figures depict actuators that are linear actuators, it is contemplated that a distance sensor can be used with non-linear or rotary actuators, especially in applications where distance from work surface is critical to the actuation of the actuator.

The controller 104 can control the movements of the tool assembly 114. For example, the controller 104 can be a servo controller that can operate a moving coil actuator. In some configurations, the controller 104 can be, for example, a Galil DMC31012 controller with built-in amplifier and a 16 bit analog output.

As is known, the controller 104, such as a servo controller, can generate control signals that operate the actuator 102. For example, in accordance with programmed instructions, typically in the form of software, the controller 104 can generate control signals and output such control signals to the actuator 102 to cause movement of the tool assembly 114 about one or more axes. In one embodiment the controller 104 is programmed to control the actuator 102 depending on the application, i.e., depending on the component to be inspected. For example, the controller 104 includes software that is specifically configured to cause the desired actuator movement and measurement for the specific component to be inspected. Typically, a computer (not shown) is coupled to the controller 104 to generate and transmit software (code representing a set of instructions to be executed) generated in a programming language to the controller for the specific application. Such software, once running on the controller 104, will instruct tool assembly 14 movements and measurements for that specific application or component.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above. Although various modules in the different devices are shown to be located in the processors of the device, they can also be located/stored in the memory of the device (e.g., software modules) and can be accessed and executed by the processors. Accordingly, the specification is intended to embrace all such modifications and variations of the disclosed embodiments that fall within the spirit and scope of the appended claims.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of ” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for positioning a tool assembly in relation to a location on a work surface, the tool assembly being mechanically coupled to an actuator, the method comprising:
generating, by a distance sensor, an output signal representative of a distance between the distance sensor and the location on the work surface;
generating a control signal based upon the output signal; and
moving, using the actuator and in response to the control signal, the tool assembly to a desired position relative to the location on the work surface.

2. The method of claim 1 wherein the moving includes moving the tool assembly to an approach position at a predetermined distance from the work surface and applying a force to the tool assembly at the approach position.

3. The method of claim 2 further including determining that at least one of the tool assembly or a component secured by the tool assembly has established soft contact with the work surface.

4. The method of claim 3 wherein the determining includes determining that a velocity of the tool assembly is equal to zero.

5. The method of claim 3 wherein the determining includes measuring a velocity of advancement of the tool assembly toward the work surface.

6. The method of claim 1 wherein the generating the output signal includes directing laser light at the work surface and determining the distance based upon reflections of the laser light from the work surface.

7. The method of claim 2 wherein the applying the force to the tool assembly includes applying an activating force to the tool assembly at the approach position in a direction substantially aligned with a linear path of movement of the tool assembly to the work surface, the activating force being substantially equal to a threshold force necessary to maintain the tool assembly in a static condition on the path.

8. The method of claim 7 further including decreasing the activating force, until the static condition of the tool assembly is changed to a dynamic condition, to advance at least one of the tool assembly or a component secured by the tool assembly through the predetermined distance from the approach position to the work surface wherein the advancement has a velocity.

9. The method of claim 8 further including measuring the velocity of the advancement and determining soft contact of at least one of the tool assembly or the component secured by the tool assembly with said work surface when the velocity is equal to zero.

10. A system comprising:
an actuator;
a tool assembly mechanically coupled to the actuator; and
a distance sensor mechanically coupled to the actuator and communicatively coupled to a controller, the distance sensor being configured to generate an output signal representative of a distance between the distance sensor and a location on a work surface and to provide the output signal to the controller;
wherein the controller is configured to generate a control signal based upon the output signal and wherein the actuator is configured to move, in response to the control signal, the tool assembly to a desired position relative to the location on the work surface.

11. A system comprising:
a moving coil linear actuator;
a tool assembly mechanically coupled to the moving coil linear actuator; and
a laser measurement sensor mechanically coupled to the actuator and communicatively coupled to a controller, the laser measurement sensor being configured to measure a distance from the laser measurement sensor to a work surface and to provide an output signal representative of the distance to the controller;
wherein the controller is communicatively coupled to the moving coil linear actuator and to the laser measurement sensor, the controller being configured to provide a control signal to the moving coil linear actuator in response to the output signal.

12. The system of claim 11 wherein the tool assembly is configured to at least one of couple to a component, dispense a material, engrave the work surface, cut the work surface, and weld the work surface.

13. A method for positioning a tool assembly coupled to an actuator in relation to a location on a work surface, the method comprising:
positioning a distance sensor adjacent to a location on the work surface;
sensing a distance from the location on the work surface to the distance sensor;
providing a signal representative of the distance;
comparing, based upon the signal, the distance to a predefined distance, adjusting a positioning routine based on the comparison; and
moving, using the actuator and in accordance with the positioning routine, the tool assembly to a desired position relative to the location on the work surface.

14. A method for positioning a tool assembly of an actuator in relation to a location on a work surface, the method comprising:
topographically mapping the work surface;
generating map data representative of the location on the work surface, the map data including the position of the location on the work surface relative to an origin point;
comparing predetermined information representative of the location on the work surface and the map data, the predetermined information including at least an x and a y position of the location on the work surface relative to the origin point;
determining, based upon the comparing, an actuation position of the tool assembly corresponding to the location on the work surface;
adjusting, based upon the determining, an actuation routine; and
moving, using the actuator and in accordance with the actuation routine, the tool assembly to the actuation position.

15. The method of claim 14 wherein the moving further includes moving the tool assembly from the actuation position into soft contact with the work surface.
